(19) United States
(12) Patent Application Publication
(10) Pub. No.: US 2003/0184084 A1
(43) Pub. Date: Oct. 2, 2003

(54) Replaceable corrosion resistant tool joint seal

(76) Inventor: Thomas E. Winship, College Station, TX (US)

Correspondence Address: Carlos A. Torres, Browning Bushman P.C., Suite 1800, 5718 Westheimer, Houston, TX, 77057, US

(21) Appl. No.: 10/113,108

(22) Filed: Apr. 1, 2002

(51) Int. Cl. F16L 55/00

(52) U.S. Cl. 285/55; 285/334.1

(57) ABSTRACT

A threaded pipe connector having a replaceable seal member. The tapered pin nose seal area of a high-pressure drill pipe tool joint is provided with an annular corrosion resistant element that is formed separately from the tool Joint. The corrosion resistant element is received in the annular space normally occupied by the tapered pin nose seal. The corrosion resistant element is secured to the tool Joint by a shrink fit technique, mechanical bonding, non-corrosive welding or other suitable means. The desired tapering annular seal surface may be machined on the corrosion resistant element following its placement on the tool Joint or may be pre-formed before being secured to the tool Joint. The corrosion resistant element is removed and replaced as required to repair corrosion damage or other mechanical damage to the seal surface.

### FIELD OF THE INVENTION

The present invention relates generally to the connectors used to secure together the ends of tubular bodies. More particularly, the present invention relates to a replaceable corrosion resistant seal in the threaded connection used for securing two pipe bodies together.

### BACKGROUND OF THE INVENTION

Tubular sections of pipe are secured together to form elongate pipe strings used in the drilling and production of wells that extract hydrocarbons and other minerals from the earth. The connection between adjacent pipe sections is usually accomplished by engaging and interconnecting mating threads machined at ends of the sections. The male component of the connection is typically referred to as a “pin” and the female component of the connection is typically referred to as a “box”. In some connections, the engaged threads function as a pressure seal as well as a mechanical structure holding the two sections together. Improved pressure containment and mechanical securing characteristics are attained when the pin and the box of the connection are each machined to include metal shoulders that, upon full threaded engagement of the pin within the box, engage to produce a metal-to-metal seal. Some connectors are supplemented with an elastomeric seal ring that is carried in a groove provided in the pin or box of the connection. Conventional drill pipe connections use threads to secure the pipe sections together and use an integrally formed, machined metal-to-metal seal to provide the required pressure containment. Elastomeric pressure seals are not commonly employed in drill pipe connections.

Pressure containment by metal-to-metal seals relies on continuous engaged surface contact and sufficient bearing pressure between the engaged shoulder surfaces of the pin and box connections. The contact surfaces for the metal-to-metal seals in drill pipe connections are exposed to erosion and corrosion caused by the flow and corrosive nature of the drilling fluids. Erosion, corrosive pitting and other mechanical damage imposed on the metal-to-metal seals in threaded tubulars can provide a leakage path for high-pressure drilling fluids contained within the engaged tubulars. The flow of high-pressure drilling muds and other fluids through the leakage path can quickly erode and destroy the threaded connection. The seal leakage may ultimately cause a separation of the string deep within a well bore or, more seriously, may lead to the loss of pressure control in the well bore permitting the well to blow out.

In addition to the damage caused by corrosion, the metal-to-metal seals used in threaded tubular may also be damaged through improper handling or usage. Any mechanical damage to the sealing surface can lead to failure of the connection, providing a leakage path and attendant dangers.

Corrosion and mechanical damage are common in the connections of tubular connectors, particularly drill pipe, requiring constant vigilance. The connectors are periodically inspected for corrosion and mechanical damage and, if the damage is not extreme, the threads and seals may be redressed or otherwise repaired. The design of most metal-to-metal seals employed in drill pipe connectors and other work string connectors permits only limited repair. Extensive pitting or deep cuts in the sealing surface may not be repairable by simple refinishing techniques. When the seal or thread damage becomes excessive, the entire threaded area at the end of the pipe section must be re-machined. Repair of damaged pins and boxes by re-machining is also limited to those situations where sufficient metal remains on the pipe end to accommodate the process. The entire section of pipe must be discarded if the end connection may not be re-machined.

### SUMMARY OF THE INVENTION

The pin nose seal of a threaded connector formed at the end of a tubular pipe section is provided by a separately formed, removable seal member constructed of a corrosion resistant material. The seal member is bonded or adhered to the pin of the threaded connector by any suitable method, including shrink fitting, metal welding, chemical bonding, adhesive sticking, threading or other suitable means. A damaged seal member is removed from the pin and replaced with a new seal that it bonded back into position on the pin end. Provision of a replaceable seal member simplifies the repair of damaged seal surfaces and extends the useful life of the tubular pipe section.

From the foregoing, it will be appreciated that a primary object of the present invention is to bond a corrosion resistant, nonelastomeric, seal member onto the pin of a threaded connector formed at the end of a tubular pipe section whereby, following damage to the seal member, the damaged seal member may be unbonded from the pin and replaced with an undamaged similar seal member that is bonded back onto the pin.

The foregoing object, features and advantages, as well as others, will be more fully understood and appreciated by reference to the following drawings, specification and claims, which more fully describe the present invention.

### BRIEF DESCRIPTION OF THE DRAWINGS

FIG. 1 is a vertical elevation, partially broken away and foreshortened, illustrating a drill string comprised of interconnected drill pipe sections;

FIG. 2 is a cross sectional view of a conventional drill pipe pin connection illustrating a conventional tapered pin nose seal;

FIG. 2A is an enlarged sectional view illustrating details in the configuration and construction of the pin nose seal of FIG. 2;

FIG. 3 is a cross sectional view of a pin connection of the present invention illustrating a removable corrosion resistant seal member;

FIG. 3A is an enlarged sectional view illustrating details in the configuration and construction of the removable corrosion resistant pin nose seal member of FIG. 3;

FIG. 3B is an enlarged sectional view illustrating details in the configuration and construction of a removable corrosion resistant pin nose seal member secured by a threaded engagement with the pin; and,

FIG. 4 is a cross sectional quarter view illustrating a tool Joint pin of the present invention engaged in a tool Joint box.

### DESCRIPTION OF THE ILLUSTRATED EMBODIMENTS

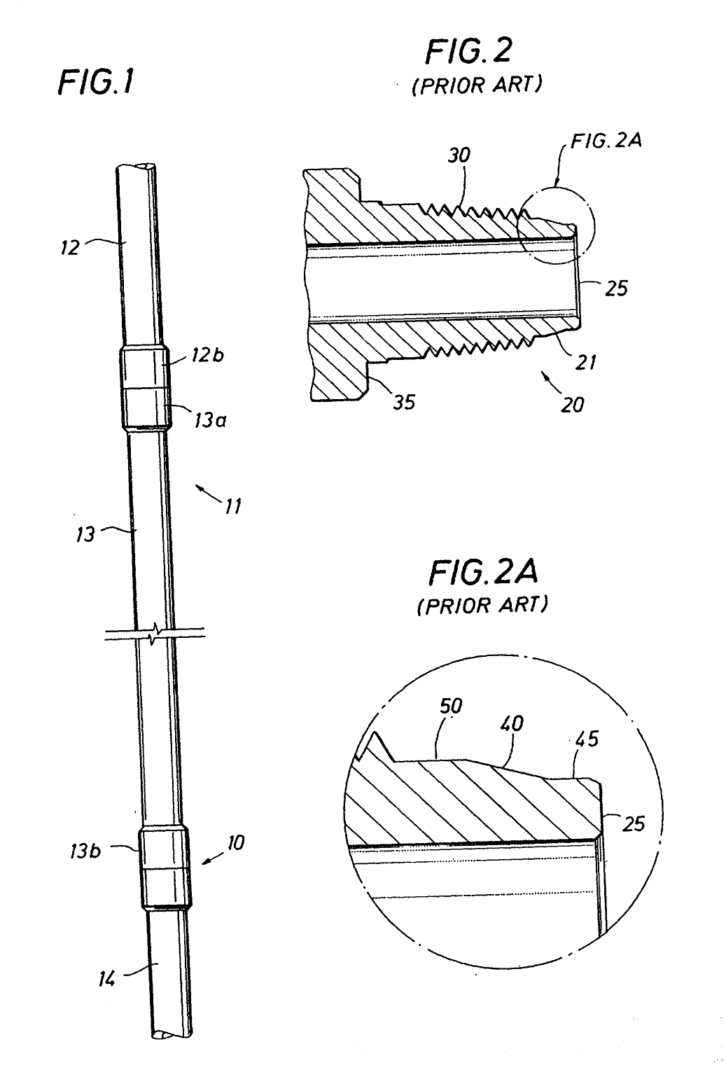

The connector of the present invention is indicated generally at 10 in FIG. 1, assembled as a pin member in a string of drill pipe 11. While the Invention is illustrated as a part of a tool Joint in a string of pipe used as a drill string, it will be appreciated that the invention has wider applicability and may be employed in the threaded end engagement between any tubular bodies.

The drill string 11 is formed by the engagement of individual pipe sections 12, 13 and 14. With the orientation illustrated in FIG. 1, the pipe section 12 is connected by a pin end component 12b to a box component 13a of the pipe section 13. Similarly, the pipe section 13 is secured by a pin section 13b to a box section 14a of the pipe section 14.

FIG. 2 illustrates a conventional prior art tool Joint pin connector indicated generally at 20. The connector 20 includes an annular, tapered pin nose seal area 21 that encircles the pin body intermediate an axial pin end 25 and external pin threads 30. A torque shoulder seal 35 is formed at the opposite end of the threads 30.

As illustrated in FIG. 2A, the pin nose seal area 21 is provided with a tapering seal surface 40 that extends between cylindrical sections 45 and 50 formed on the pin nose. The surface 40 conventionally tapers approximately 15 degrees relative to the central axis of the connector. When the pin 20 is fully engaged with a box connection, the tapered sealing surface 40 engages and seals with a correspondingly configured seal surface within the box member to provide a torque shoulder and pressure seal between the engaged pin and box components. The engaged relationship between pin and box torque shoulders and sealing surfaces of the prior art connection is similar to that illustrated in FIG. 4 depicting an engaged pin and box of the present invention.

With reference to FIG. 2A, the tapered sealing surface 40 is exposed to a variety of corrosive fluids during its use in drilling or completing a well. The corrosive fluids pit and otherwise erode the surface of the area 40 allowing the pressurized fluid contained within the connector to escape. The surface 40 is also frequently damaged mechanically during the handling and assembly of the drill pipe string. Such damage can occur, for example, when the pin of a pipe section that is being added to the string strikes the edge of the box at the top of the pipe string. Another frequent incident of damage occurs when the pin is the bottom member in a multiple section stand of the drill pipe that is rested on the pin end in vertical storing arrangements on the rig floor. Mechanical damage to the corresponding tapered box seal of a conventional tool Joint connector is less likely because of its protected position within the interior of the box.

Refacing the surface can repair minor damage to the surface 40, however repairs that require the removal of more than a minimal amount of material can render the connection unable to contain high pressure. In this regard, it may be appreciated that the final engaged position between the pin and box of the connector is determined by engagement of the pin 25 and shoulder 35 with mating components in the box of the connector. Removal of material from the surface 40 may axially displace the seal surface 40 from the corresponding seal surface in the box connector, permitting the connection to leak.

A conventional pin connector that has been damaged can be redressed until a maximum of approximately ⅛ inch of material, measured axially, has been removed. Refacing or redressing the connection usually requires that the torque shoulders 25 and 35 also be redressed to permit the tapered 15 degree sealing surfaces between the pin and box to close together. Remachining the connection can only repair damage occurring after the ⅛-inch of material has been removed.

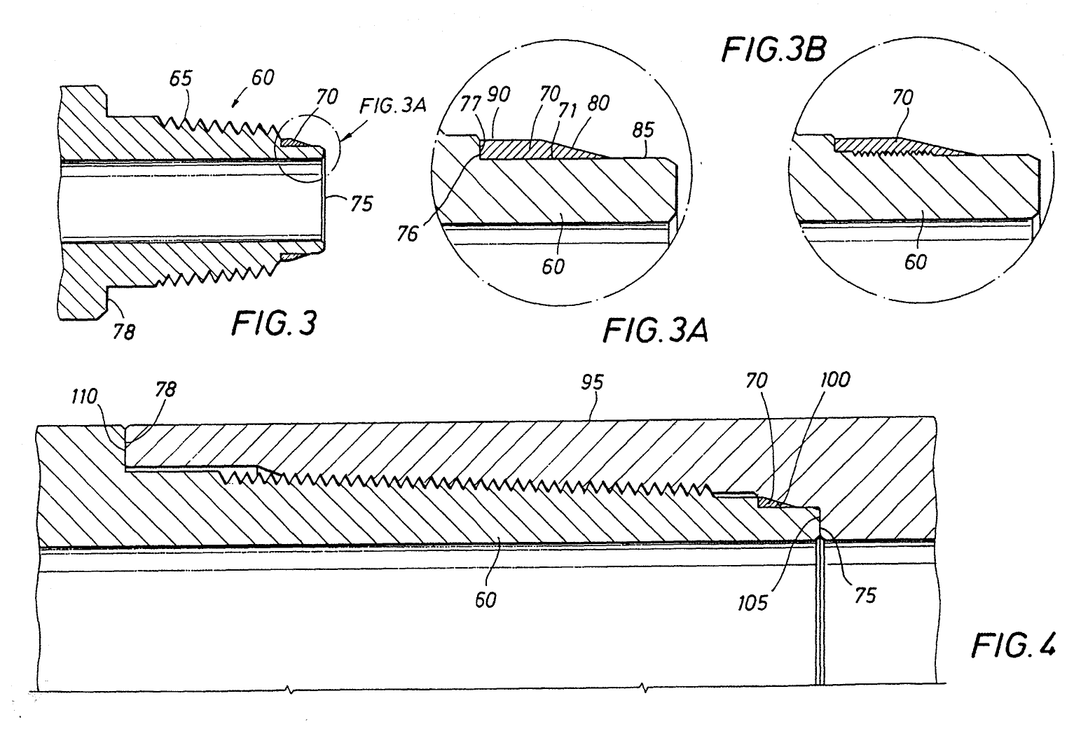

FIG. 3 of the Drawings illustrates a pin connector of the present invention indicated generally at 60. The connector 60 includes an axially extending, threaded pin connection area formed on the radially external surface at the end of a tubular pipe section. Conventional pin threads 65 extend helically along the external pin surface. A pin nose seal member 70 is bonded to the pin 60 about an annular seal receiving segment 71 intermediate the pin threads 65 and an axial end 75 of the pin.

The pin nose seal member 70 is constructed separately from the machining or other construction of the threaded pin 60 and is preferably added to the pin after the pin has been constructed. It may be desired in some circumstances to machine the assembled pin 60 and the seal member 70 after bonding the seal member to the pin.

An annular axial end 76 of the seal member 70 engages an annular shoulder 77 formed at one axial end of the receiving segment 71. As may best be seen by reference to FIG. 4, the engagement of the seal member end 76 against the shoulder 77 resists axial movement of the seal member 70 away from the mating seal surface in the box as the pin and box are being screwed together. A conventional annular torque shoulder 78 is formed on the pin 60 beyond the base of the pin threads 65.

The dimensions and external configuration of the pin 60 of the present invention are substantially the same as those of the prior art pin connector 20 illustrated in FIG. 2. As illustrated in the detail of FIG. 3A, the pin nose seal member 70 includes a tapering annular sealing surface 80 formed radially externally on the seal member 70. The seal surface 80 tapers radially inwardly toward the pin axis in an axial direction toward the pin end 75, between an external cylindrical seal member surface 85 and an external cylindrical pin nose surface 90. The configuration and external dimensions of the pin 60 of the present invention are selected so that the pin will mate with an annular seal surface in a conventional, internally threaded box connector in a connecting pipe section.

The annular seal member 70 may be bonded to the body of the pin 60 using any suitable technique, including heat shrinking, mechanical or chemical bonding, chemical adhesion, welding or other suitable means. The mechanical bonding may be obtained by providing a threaded engagement between the seal member 70 and the body of the pin 60, as illustrated in FIG. 3B. While the preferred form of the invention anticipates that the seal member 70 is rigidly and immovably affixed to the pin nose receiving segment 71, the seal member 70 may be movably affixed to the pin 60 in any suitable manner. As employed herein, the terms “bond” or “bonded” are intended to include any technique or mechanism employed in affixing the seal member 70 to the seal receiving segment 71. The terms “bond” or “bonded” are also intended to describe an association between the pin and seal member in which limitations are imposed on the movement of the seal member relative to the pin nose. The terms “bond” or “bonded” include affixing the seal member 70 to the receiving segment 71 such that the seal member 70 is either immovably or movably affixed to the pin nose.

The material of the seal member 70 may be any suitable corrosion resistant, mechanically strong, nonelastomeric, material. It is preferable that, if the material of the seal member 70 is a metal, the metal be the same metal as that comprising the body of the pin 60. A carbon steel alloy in the American Iron and Steel Institute (AISI) 4100 series is a preferred material for the member 70 when employed on a pin of the same composition. The separately formed member 70 may also be constructed of any high nickel content material, chrome alloys, bronze, titanium or other suitable material. While the seal member 70 is preferably constructed of a metal, it will be appreciated that other materials meeting the strength and durability requirements of a seal in a high-pressure, threaded connector may also be employed in the construction of the member 70. It will also be appreciated that the yield strength of the material forming the member 70 may be selected to be greater or less than that of the material against which the member 70 is to be engaged to provide the desired seal. Depending upon the circumstances of the application of the connector, it may be desirable to select a material for the seal member 70 having a yield strength best suited for the application.

FIG. 4 illustrates the tool Joint pin 60 of the present invention engaged in a conventional tool Joint box 95. The annular pin nose seal member 70 of the present invention is illustrated engaging and sealing with a surrounding frustoconical sealing surface 100 formed internally of the box 95. The axial end 75 of the pin 60 is illustrated engaging an internal shoulder 105 formed at the base of the internally threaded area of the box 95. The engagement of the shoulder 105 and pin end 75 cooperates with the interfering engagement between the annular seal member 70 and the internal box seal surface 100 to provide an internal pressure seal that contains the pressure confined within the tubular members secured by the connection of the pin and box. If the seal member 70 is bonded to the pin 60 in a manner that does not provide a pressure seal between the member 70 and the pin 60, a pressure seal is effected by the bearing pressure exerted between the box seal surface 100 and the seal member seal surface 80.

The torque shoulder 78 of the pin 60 is illustrated engaging the axial end 110 of the box 95. The shoulder 78 functions as a torque shoulder that permits tensile loading of the engaged threads between the pin and box. Engagement of the torque shoulder also provides an external seal that prevents the incursion of corrosive fluids in the threaded area between the pin and box.

It will be appreciated that as the annular pin nose seal member 70 wears or is eroded away along the tapered surface 80, axial spacing may occur between the surface 80 and the surrounding box seal surface 100. Redressing or resurfacing measures taken in an effort to reestablish a continuous sealing surface may also cause axial spacing between the two sealing surfaces. When the seal member 70 exhibits a metal loss through mechanical damage, wear or corrosion that is sufficient to permit leakage, the member 70 is completely removed from the pin 60 and replaced with a similar annular corrosion resistant member to restore the pin 60 to its new configuration.

While preferred forms of the present invention have been described herein, various modifications in form, materials and methods of construction and application may be made without departing from the spirit and scope of the Invention, which is more fully defined in the following claims.

What is claimed is:

1. A threaded pipe connector having a replaceable seal member, comprising:
a pin connector having an axially extending threaded pin connector area formed on the radially external surface at the end of a tubular pipe section,
an annular seal receiving segment formed on said axially extending threaded pin connector area,
a separately formed, nonelastomeric annular seal member bonded to said annular seal receiving segment, and
an annular sealing surface formed radially externally on said annular seal member for engagement with a mating annular seal surface in an internally threaded box connector.

2. A threaded pipe connector as defined in claim 1, wherein said annular seal member includes a tapered annular sealing surface and further comprising an internally threaded box connector engaged with said pin connector.

3. A threaded pipe connector as defined in claim 1, further comprising:
an internal box shoulder formed internally of said box connector, and
an annular pin shoulder formed on an axial end surface of said pin connector, said annular pin shoulder adapted to engage said internal box shoulder to form an internal torque shoulder when said pin and box connector are fully engaged.

4. A threaded pipe connector as defined in claim 1, further comprising:
an annular external box shoulder formed on an axial end surface of said box connector, and
an annular external pin shoulder formed on an external surface of said pin connector, said external pin shoulder adapted to engage said external box shoulder to form an external torque shoulder when said pin and box connector are fully engaged.

5. A threaded pipe connector as defined in claim 3, further comprising:
an annular external box shoulder formed on an axial end surface of said box connector, and
an annular external pin shoulder formed on an external surface of said pin connector, said external pin shoulder adapted to engage said external box shoulder to form an external torque shoulder when said pin and box connector are fully engaged.

6. A threaded pipe connector as defined in claim 2, wherein said pin and box connector and said annular seal member are constructed of the same material.

7. A threaded pipe connector as defined in claim 2, wherein said pin and box connector are constructed of a material different from the material of said annular seal member.

8. A threaded pipe connector as defined in claim 1, wherein said annular seal member is constructed from a metal alloy.

9. A threaded pipe connector as defined in claim 1, wherein said annular seal member is constructed from a corrosion resistant metal that is softer than the material of the pin and box connector.

10. A threaded pipe connector as defined in claim 1, wherein said annular seal member is constructed from a metal alloy containing nickel.

11. A threaded pipe connector as defined in claim 1, wherein said annular seal member is constructed from a metal alloy containing copper.

12. A threaded pipe connector as defined in claim 1, wherein said annular seal member is constructed from a nonelastomeric material other than metal.

13. A threaded pipe connector as defined in claim 1, wherein said annular seal member is welded to said annular seal receiving segment.

14. A threaded pipe connector as defined in claim 1, wherein said annular seal member is mechanically bonded to said annular seal receiving segment.

15. A threaded pipe connector as defined in claim 1, wherein said annular seal member is chemically bonded to said annular seal receiving segment.

16. A threaded pipe connector as defined in claim 1, wherein said annular seal member is heat-shrink bonded to said annular seal receiving segment.

17. A threaded pipe connector as defined in claim 2, wherein said tapered annular sealing surface includes a 15-degree taper relative to a central axis of said pin connector.

18. A threaded pipe connector as defined in claim 1, wherein said annular seal member is threaded onto said annular seal receiving segment.

19. A threaded pipe connector as defined in claim 3 wherein said tapered annular sealing surface includes a 15 degree taper relative to a central axis of said pin connector.

20. A threaded pipe connector as defined in claim 2 further comprising:
an annular internal box shoulder formed radially internally of said box connector, and
an a annular internal pin shoulder formed on an external surface of said pin connector, said internal pin shoulder adapted to engage said internal box shoulder to form an internal torque shoulder when said pin and box connector are fully engaged.

21. A threaded pipe connector as defined in claim 20, further comprising:
an annular external box shoulder formed on an external axial end surface of said box connector, and
an annular external pin shoulder formed on an external surface of said pin connector, said external pin shoulder adapted to engage said external box shoulder to form an external torque shoulder when said pin and box connector are fully engaged.

22. A threaded pipe connector as defined in claim 16 wherein said tapered annular sealing surface includes a 15 degree taper relative to a central axis of said pin connector.

23. A threaded pipe connector as defined in claim 10, wherein said annular seal member is heat-shrink bonded to said annular seal receiving segment.

24. A threaded pipe connector as defined in claim 1 wherein multiple threaded pipe sections are secured together through multiple pin and box connectors for forming a pipe string.

25. A method of applying a seal surface to a threaded pipe pin connector, comprising:
forming threads on an external end area of a pipe to form a pin connector,
forming an annular seal receiving segment on said pin connector,
bonding a first annular seal member to said annular seal receiving segment to form an external seal surface adapted to engage and seal with a mating seal surface in a threaded pipe box connector,
removing said first annular seal from said annular seal receiving segment, and
bonding a second annular seal into said annular seal receiving segment to form an external seal surface adapted to engage and seal with a mating seal surface in a threaded pipe box connector.

26. A method as defined in claim 25, further comprising:
bonding said first annular seal to said annular seal receiving segment by heat-shrinking said first annual seal to said annular seal receiving segment.

27. A method as defined in claim 25, further comprising forming said first and second annular seal components of a metal.

28. A method as defined in claim 25, further comprising securing said threaded pin connector to a threaded box connector to form a pipe string.

29. A method as defined in claim 25, further comprising rigidly securing said first annular seal to said seal receiving segment whereby said annular seal is immovable relative to said pipe pin connector.

30. In a tubular connector comprising a box member having internal threads and a central axis, and a pin member having external threads and a central axis, wherein the pin and box are threadedly engageable when the pin and box are axially aligned, and the box further having a box sealing surface axially inward from the box internal threads and radially centered on the box central axis, the improvement comprising:
a seal member releasably attached to the pin member distal of the pin external threads and adapted for sealing engagement with the pin and with the box sealing surface upon threaded engagement of the pin and box.

31. The tubular connector of claim 30, further including:
the pin member having a radial seating surface distal of the pin external threads and radially spaced from the pin central axis for receiving the seal member; and
the seal member having a radial inner surface for sealing engagement with the pin sealing surface and having a radial outer surface for sealing engagement with the box sealing surface upon threaded engagement of the pin and box.

32. The tubular connector of claim 30 , wherein said seal member is constructed of a material having a yield strength less than the yield strength of the material forming the box sealing surface.

33. The tubular connector of claim 30, wherein said seal member is constructed of a material having a yield strength greater than the yield strength of the material forming the box sealing surface.

34. The tubular connector of claim 30, wherein said seal member is constructed of material that is the same as the material of said pin and box.
